(19) United States
(12) Patent Application Publication
(10) Pub. No.: US 2005/0209886 A1
(43) Pub. Date: Sep. 22, 2005

(54) System and method for tracking patient flow

(76) Inventor: Robert S. Corkern, Batesville, MS (US)

Correspondence Address: W. EDWARD RAMAGE, COMMERCE CENTER SUITE 1000, 211 COMMERCE ST, NASHVILLE, TN, 37201, US

(21) Appl. No.: 11/052,335

(22) Filed: Feb. 7, 2005

Related U.S. Application Data
(60) Provisional application No. 60/542,030, filed on Feb. 5, 2004.

(51) Int. Cl. G06F 17/60

(52) U.S. Cl. 705/2; 235/377

(57) ABSTRACT

The invention provides a system and method for tracking the progress of patient in a healthcare or medical facility, including an emergency room or department. The system requires minimal additional input of data from busy facility personnel or administrators. Tracking of patients is accomplished using RFID tags with unique identification numbers attached to individual patient charts, and determining the presence of the charts and the time deposited in a chart rack or holder at various stations in the facility through RFID interrogators that detect the RFID tags on the charts when they are placed in the rack. The system monitors the time a patient chart remains at a particular station, and can provide alerts when patient charts remain longer than a certain period of time. The system also stores the data collected over a period of time and can provide reports on patient flow through the facility.

This application claims benefit of the previously filed Provisional Patent Application No. 60/542,030, filed Feb. 5, 2004, by Robert S. Corkern, and is entitled to that filing date for priority.

### BACKGROUND OF THE INVENTION

In health care settings, tracking of patients, patient services, medications, and other items or services can provide both better immediate management of patient care and better long-term management as tracking reports are evaluated to determine where problem areas, such as bottlenecks, exist. In healthcare delivery systems, patient flow can be critical, both to the individual patient and to the overall patient population. For example, one patient's extended stay in the emergency room can help to place the hospital on bypass status or critical-care divert status, reducing the facilities that are available when services are needed most. Bypass status means that no ambulances can bring patients to the emergency department, and critical-care divert status means that ambulances cannot bring critical care patients to the emergency department.

Patient progress through the emergency department and related departments that cooperate in emergency care and diagnosis can be hampered by the sheer volume of patients that must be moved from one department or station to another. Individual patients can be held too long in an area because emergency department personnel are not aware that these patients are ready to be transported to the next station. This can result in lost time, patient frustration, and bottlenecks that limit the number of patients that can be admitted.

Tracking systems for medical or other records are known in the art. For example, Chung (U.S. Patent Application No. 2003/0052788A1, published Mar. 20, 2003) describes a tracking system that is used to insure that proper prescriptions are administered to a hospital patient. The system utilizes a dual-item tracking system to match a patient and patient medication record with the correct medication. Eisenberg, et al. (U.S. Patent Application No. 2002/0196126A1, published Dec. 26, 2002) describes a system that tracks the location of file folders on shelves, the system detecting the presence of file folders once placed in a file storage shelf. Maloney (U.S. Pat. No. 6,204,764) describes an object tracking system that detects the deposit and removal of a file in a file storage compartment, the system comprising a Radio Frequency Identification (RFID) tag, also known as a “smart” tag, associated with each file, and an interrogator to read and record the identity of the file. The system is also described as useful for tracking the removal and return of keys from a central storage location.

Tracking systems for patients and their medical information also have been described in the art. For example, Cole, et al. (U.S. Patent Application No. 2003/0078811, published Apr. 24, 2003), describes a “Resource Monitoring System for Processing Location Related Information in a Healthcare Enterprise.” Keck (U.S. Patent Application No. 2003/0050794, published Mar. 13, 2003) describes a hospital emergency department resource utilization and optimization system that provides a patient tracking system with medical and/or insurance information, as does Guan, et al. (U.S. Patent Application No. 2002/0194029, published Dec. 19, 2002). And Jackson (U.S. Patent Application No. 2002/0188473, published Dec. 12, 2002) describes a “smartcard” that can be carried by a patient, the card containing information that identifies the insurance carrier as well as information related to access a database that may include the patient's medical history and other important patient information.

These systems, however, require a significant input of information and produce multiple data sets. To provide information which can be of value to hospital administration in identifying treatment bottlenecks, it is important to provide a system that minimizes the input required by hospital personnel and does not require active monitoring of patient information or patient location information by hospital personnel.

Barcodes and RFID tags have made it easier to track objects and files, and to provide medical information for patients in a more timely and mobile fashion, as well as to match the correct medication to the correct patient. This technology can be used to monitor patient flow in heavily-trafficked healthcare facilities, such as emergency departments of hospitals. However, the very nature of emergency departments makes it difficult to conduct patient tracking. Diagnostic procedures must be performed as quickly as possible, patients must be admitted with a minimum of effort and input of information, and the sheer volume of patients being moved from one diagnostic or therapeutic service to another upon admission to an emergency department makes it difficult to determine which patients have remained for too long in any one associated department or laboratory, and which departments may need to streamline their procedures in order to diagnose and treat patients in a more timely manner.

Accordingly, what is needed is a simple and straightforward system and method for reporting the progress of patient movement in a health care facility, such as an emergency room, that requires minimal data input per patient.

### SUMMARY OF THE INVENTION

The present invention relates to a system and method for tracking patient progress through various stations or departments within a hospital in association with admission to the emergency department. The system comprises one or more patient charts that are individually associated with a corresponding Radio Frequency Identification (RFID) tag, one or more racks for the one or more patient chart, each rack being associated with a reader or interrogator for collecting information from each RFID tag when the chart is placed in the rack, and a data interpretation station operably connected to the reader or interrogator for collecting the information gathered from the RFID tags.

An exemplary embodiment of the method of the present invention for tracking patient flow through an emergency department of a healthcare facility comprises the following steps: associating at least one patient chart with an RFID tag encoded with information for identifying the patient chart; associating at least one chart holder with an RFID interrogator to read the information; linking at least one RFID interrogator associated with at least one chart holder to a monitoring system for collecting information from the RFID interrogator; assigning to at least one patient a chart upon arrival in the emergency department, the RFID tag associated with the chart being encoded with a patient identification number; and monitoring the information from the RFID interrogator to determine the time interval between placement of the chart into the chart holder and removal of the chart from the chart holder. In one embodiment of the invention, a predetermined time interval that is recommended as a minimum average amount of time that a patient should remain at a particular station, such as a department or laboratory, for example, is programmed into the monitoring system so that an alarm is produced to alert healthcare workers whenever a patient has remained for longer than that interval at any one particular station. In another embodiment, a report is generated to indicate the length of time each patient remained at any particular station during a typical reporting period. Such reports can comprise the basis for assessing the efficiency of each department or laboratory and can identify bottlenecks that should be addressed in order to improve patient care.

### BRIEF DESCRIPTION OF THE DRAWINGS

FIG. 1 is a top and bottom view of a patient chart with RFID tag in accordance with one embodiment of the present invention.

FIG. 2 is a side view of a chart holder with multiple charts in accordance with one embodiment of the present invention.

FIG. 3 is a flowchart of a system for tracking patient charts in an emergency room in accordance with one embodiment of the present invention.

FIG. 4 is a schematic diagram a system for tracking patient charts in a facility in accordance with one embodiment of the present invention.

### DETAILED DESCRIPTION

The inventors provide a novel system and method for tracking patient progress by tracking the position of a patient chart through a medical or healthcare facility, including but not limited to an emergency room or department, in order to ensure timely patient care, identify delay areas and minimize bottlenecks. The system comprises a combination of a Radio Frequency Identification (RFID) tag associated with each patient chart and chart racks equipped with a reader to collect information from the RFID tag. While ideal for tracking patient progress in an emergency room setting, it is also useful for patient tracking in other health care settings, such as walk-in clinics, and its use is not intended to be limited to emergency departments.

As used herein, and as shown in the numerous figures, wherein like references identify like elements of the invention, a patient chart 4 is any collection of patient records 3, preferably with an associated holder for the documents, such as a folder, clipboard, binder, or the like 1, to which an RFID tag 2 can be attached so that the patient's progress can be tracked through an emergency department, walk-in-clinic, or other healthcare facility once the RFID tag 2 is encoded with or associated with a patient identification number. “Charts,” as the term is used by those of skill in the medical arts, generally comprise the aforementioned folder, clipboard, binder, or the like 1, along with the paperwork 3 they are intended to contain. A chart holder or chart rack 6 is a storage location for the charts 4. Typically, charts can be dropped into hanging file folders and hung by means of a component on the chart rack or holder that can support a complementary component on the chart, or placed into a slot or other holder for the chart. One type of chart holder, for example, could comprise a rack upon which charts comprising clipboards could be hung. A “station,” as used herein, comprises a department, sub-department, clinic, laboratory, or other similar diagnostic or therapeutic service center that is associated with a medical or healthcare facility, emergency department, or walk-in clinic, and to which a patient may be sent or transported during the course of the patient's admission to or treatment in the facility, emergency department or clinic. Examples of such stations include, but are not limited to, an X-ray department, a hematology laboratory, an infectious disease diagnostic laboratory, an orthopedic clinic, or other similar departments or clinics.

The present invention provides patient tracking with a minimum of input of patient information by physicians, nurses, or other staff. This is an advantage particularly for emergency departments faced with the task of providing a diagnosis and urgently needed treatment. In one exemplary embodiment, the present invention meets this need for a highly efficient method of patient tracking by tracking the patient chart 4 that would be associated with each patient upon entry or admission to the facility, emergency department, or clinic. RFID tags 2 provide a way to identify or track an object, such as a patient chart, using a radio frequency transmission (Automatic Identification Data Capture (AIDC)). RFID tags can be read or written at distances up to several feet, while in motion or in any orientation. Several RFID tags can automatically be read at once, while barcodes, in contrast, have to be manually scanned one at a time.

An RFID tag 2, or transponder, consists of a microchip attached to an antenna. Tags can either be active (with an integrated battery) or passive (without a battery). Tags are commercially available from manufacturers such as Texas Instruments (TI-RFid™, Texas Instruments, Plano, Tex.). Passive tags get the power to operate from the field generated by the reader, also known as an interrogator 8. Passive tags have shorter read ranges than active tags and require a higher-powered reader. Read-only tags are typically passive and are programmed with data that cannot be modified. A reader, comprising a transceiver and decoder, and, optionally, an antenna, can be configured either as a handheld or a fixed-mount device. The reader emits radio waves in ranges of approximately one inch to 100 feet or more, depending upon its power output and the radio frequency used. The RFID reader 8, which is often connected to a computer, operates in much the same way as a barcode scanner. It performs the communication between the AIDC system and the RFID tag, often within 100 milliseconds. Read-only tags are typically passive and are programmed with a unique set of data (usually 32 to 128 bits) that cannot be modified.

The RFID reader 8, or transceiver, may be fitted with an antenna, the size depending on the communication distance required. The electromagnetic field produced by an antenna can be constantly present when multiple tags are expected continually, or the field can be activated by a sensor device if constant interrogation is not desired. The antenna activates the RFID tag 2 and transfers data by emitting wireless pulses. Often the frequencies of these pulses are in the range of 125 kHz, 13.56 MHz or 800-900 MHz, depending upon the desired use and the distance between the tag and the RFID station. An RFID station, made up of an RFID reader and an antenna, can both read information stored into the RFID tag and update this RFID tag with new information. The application software specifically designed for the required task is generally a part of the RFID station. When an RFID tag passes through the electromagnetic field, it detects the reader's activation signal. The reader decodes the data encoded in the tag's integrated circuit, and the data is relayed to the host computer for processing.

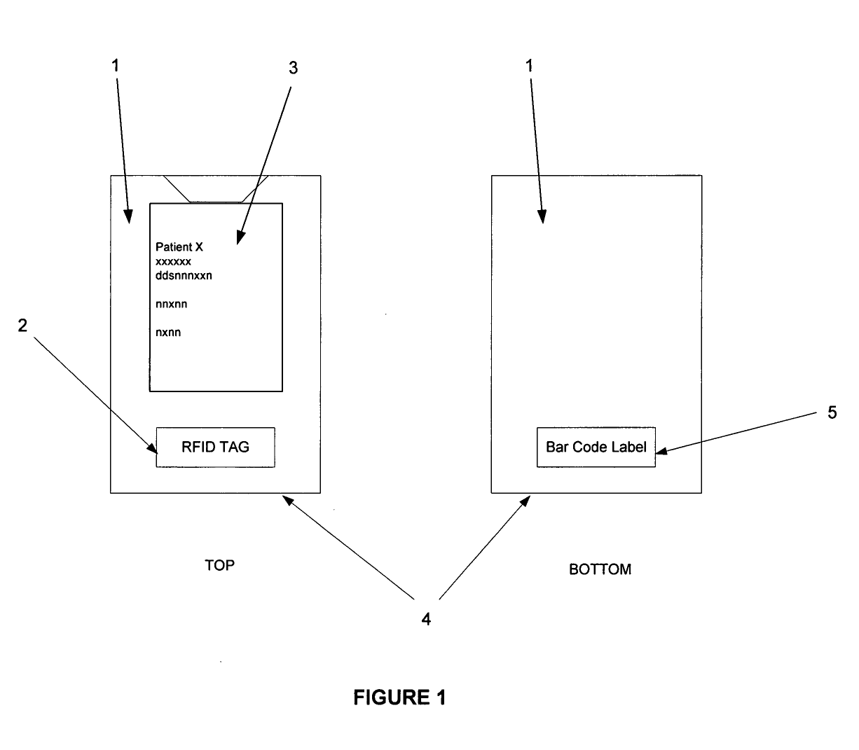

FIG. 1 illustrates an exemplary embodiment of the present invention, where the RFID tag 2 is attached to the front side of the patient chart 4 at or near the bottom. The chart 4 can be any type of clipboard or other such device typically used in a hospital or medical or healthcare setting. These charts are familiar to those of skill in the art and can be obtained from a number of medical supply and office supply companies. These charts may be fashioned from a wide variety of appropriate materials, but preferably wood or plastic (e.g., a plastic clipboard), for more effective operation of the system.

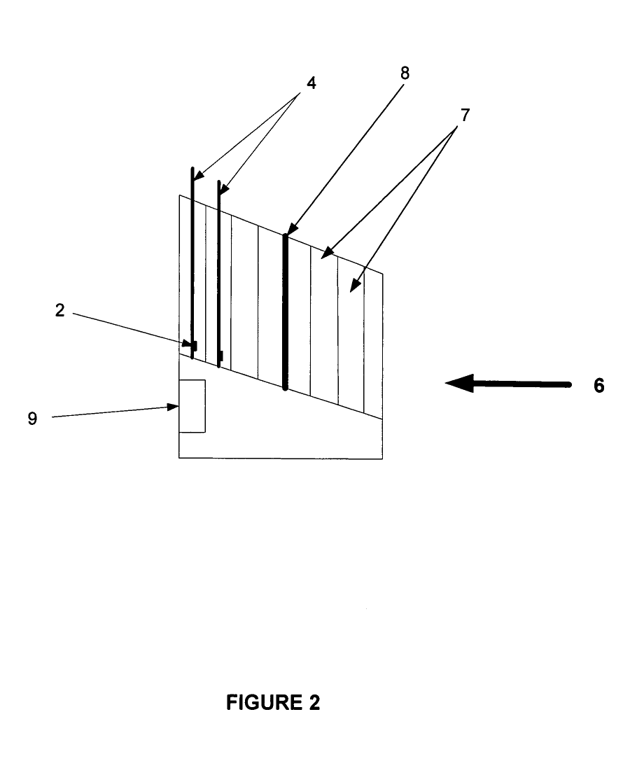

The patient charts 4 with attached RFID tags 2 may be stored in chart holders or racks 6 at various locations or stations in the healthcare or medical facility. A chart holder or rack has an accompanying RFID interrogator 8 which may be attached or integrated with the holder 6. Chart holders or racks 6 may be fashioned from a wide variety of appropriate materials, wood or plastic being preferred so as not to interfere with the electromagnetic field necessary for the RFID process, but should be of sufficient strength and configuration to hold one or more patient charts 4. The holder or rack 6 may support the charts 2 in a manner similar to a magazine rack, with charts fitting in one or more slots 7, or the rack may be designed so that the charts can hang in the rack. In one exemplary configuration, the chart holder or rack 6 should position the charts 4 so that the RFID tags 2 do not overlap, as RFID tags can become more difficult for the interrogator 8 to read reliably when they are overlapped. As shown in FIG. 2, the charts 4 may be positioned at slightly different elevations, so that the RFID interrogator 8, which may be positioned in the middle of the slots, can read the RFID tags 2 without interference. The RFID tag 2 can be either active or passive, although a passive tag is less expensive and provides the necessary information for the purposes of the invention. A radio frequency transmitter 9 provides communication to a network or computer monitoring system, although other communication means may be used.

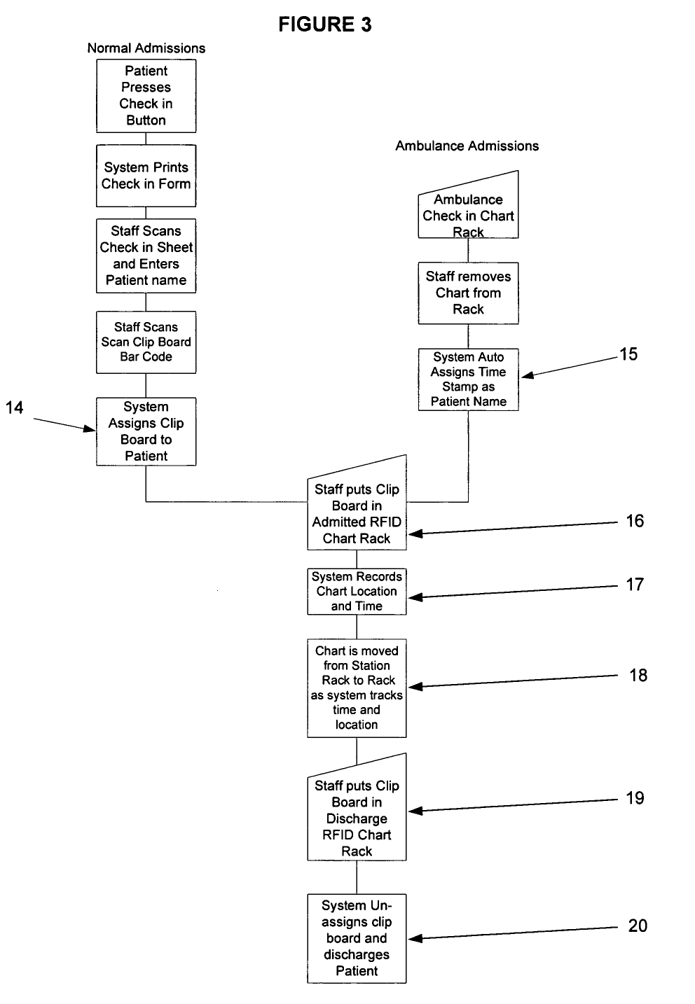

An RFID tag 2 as used in the present invention typically will be assigned a unique identification number by the manufacturer of the tag. The identification number will also be displayed as a barcode and as ASCII text. In one exemplary embodiment, as shown in FIG. 3, as the patient is admitted to the hospital or facility, a chart 4 is assigned to a new patient and the system will associate the patient name or hospital number (and possibly the time of admittance) with the chart's RFID tag identification number 14, 15. The chart 4 is placed in the RFID-enabled chart rack for admissions 16, whereupon the system records the chart location and time 17. As the patient moves from station to station within the facility, the system continues to monitor and record the chart's location and time at each station 18. Once the patient is ready for discharge, signaled by placement of the charge in the RFID-enabled discharge rack 19, the association between the patient and the identification number is discontinued, and the number can be assigned to a new patient 20. Thus, in one exemplary embodiment of the present invention, RFID tags and associated chart holders and racks can be reused and associated with different patients after they have completed their function for an earlier patient.

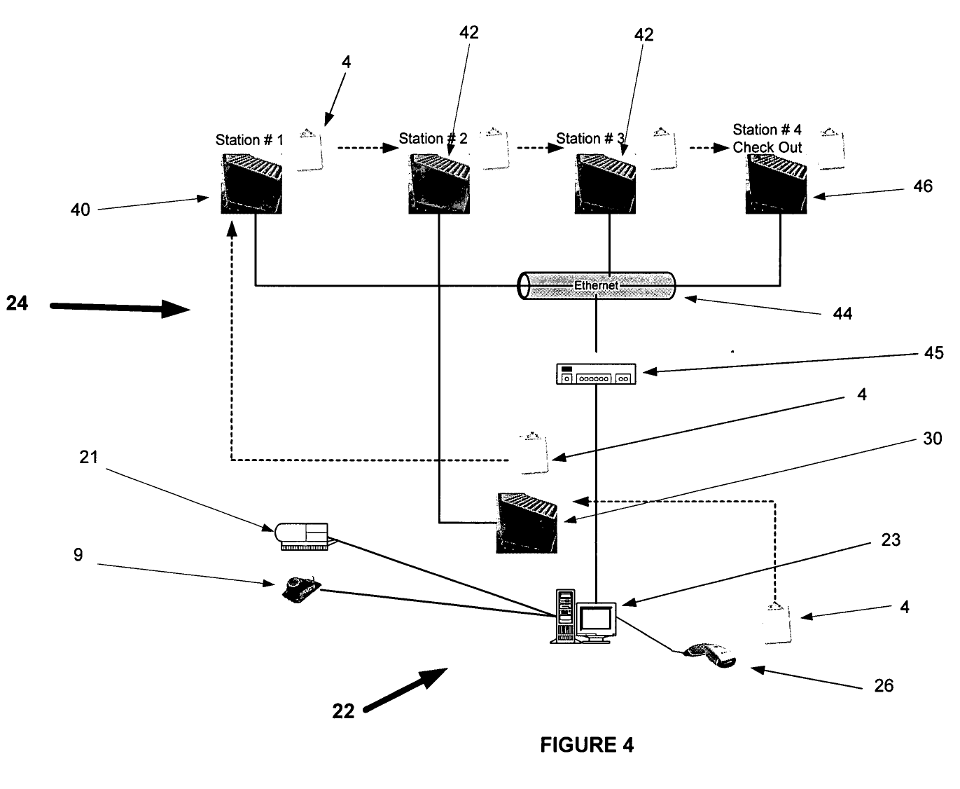

FIG. 4 shows the components of a typical patient tracking system, such as might be used in an emergency room (ER) or emergency department (ED). When a patient is admitted to the emergency room or emergency department, the patient's check-in form is printed by a check-in printer 21 at or near a check-in station 22. The check-in printer 21 is connected to a computer or processing unit 23 at or near the check-in station 22. Typically, the patient's arrival time is printed on the check-in form in barcode format, the number comprising the date and time the form was printed. The patient's name or hospital number in entered into the facility's monitoring system 24, the bar code on the check-form (e.g., time stamp) is scanned at the check-in station scanner 26, which also scans the barcode 5 on the ER patient chart 4. The system records the check in time from the check in form and assigns the patient chart 4, with its associated RFID tag, to that individual patient. The chart 4 is placed in the check-in rack 30 at the check-in station, the rack 30 having an associated RFID reader or interrogator 8 that detects and collects the identification number of the patient chart 4.

The interrogator 8 is operably connected to an operating system 24, such as a Linux system with a Prostgresql database. The system 24 includes a processing unit 23 which collects and processes the information conveyed to it from one or more interrogators 8 at the various stations, and thereby acts as a monitoring system for the patient charts, associated RFID tags, and RFID interrogators. The processing unit 23 may be the same unit at the check-in station 22, but also may be a separate, independent unit located elsewhere.

The system 24 may programmed so that it polls the interrogators 8 at the stations from time to time, preferably at regularly set time intervals. In one exemplary embodiment, the monitoring system 24 polls the interrogators 8 at regular intervals of not less than 5 seconds. In another exemplary embodiment, the polling period is not less than 30 seconds. And in yet another embodiment of the invention, the interrogators 8 are polled at 60-second intervals. The system may also be programmed to recognize an individual chart 4 after more than one, or at least two, successive scans in order to avoid the possibility that a chart will be detected as present in the chart rack after simply being passed in close proximity to the interrogator.

Upon arrival of the patient chart 4 at a first individual station 40, comprising one or more chart racks in close proximity, the system 24 records the chart number, the station number, and the time. In one exemplary embodiment, the system may be programmed so that a chart 4 that remains at a single location or station, including the check-in station 30, for more than a preset designated amount of time will be flagged by the system 24 and alarm means will be triggered. This time period may be constant for all stations, or may be separately determined for each station (or a group of stations), so that waiting times can be customized as appropriate for the station in question. Waiting times also may vary based on time of day or day of the week, or in one exemplary embodiment, may even be dynamically adjusted based on patient flow issues throughout the system and at other stations. The alarm means may comprise a variety of different alarm mechanisms, including visual and audible alerts, both at the station in question or elsewhere. The alarm mechanism may be operably connected to the monitoring system 24, and for example, may comprise an alert at a computer at a monitoring station, such as an audible beep or tone or a flashing screen or message, or a visible red, blue, or other colored light being illuminated at the station where the alarm is triggered.

A station may be any location within a healthcare setting, such as a department or laboratory. A first station 40, for example, can be located in the X-ray department, while a second may be located in a hematology laboratory, a third in a magnetic resonance imaging center, and so on.

Once moved to a second or subsequent station 42, including the check-out station 46, where the chart 4 is placed in the one or more chart racks associated with that station, the system 24 again records the patient number, the station number, and the time by means of the interrogators 8 at that station. As described above, the system 24 continues to monitor the time a chart 4 remains at each station 30, 40, 42, detects extended wait periods, and signals an alarm to alert the facility personnel that a patient has been at a particular station for more than the determined amount of time. If a chart 4 is in transit, it is considered to be in its last known location until it is detected in a new location.

The information gathered by the interrogators or readers 8 at each station 30, 40, 42 may be transmitted to the system 24 wirelessly or through some wired connection. In one exemplary embodiment, the information is transmitted via an Ethernet connection 44 or RF (radio frequency) connection to a hub (the RF hub) 45, which then transmits the data to the central processing unit 23 for data collection and generation of reports. The data is stored in a database, such as an SQL database.

Polling times can be set as needed, but should be at least about 5 seconds apart. In one embodiment of the invention, polling can be set for intervals of one minute. Reports generated from the polling data provide each station the chart entered and how long it remained at that station. The report also provides information regarding the total time from start to finish that a patient was under examination at various stations associated with the ER. The alarm reports display station name, patient number, and the number of minutes over which the threshold acceptable time was exceeded. Alarm reports can be compiled to give the charts and stations that exceeded the acceptable wait times, allowing ER personnel to better evaluate those stations that may need additional personnel or may need to be better managed for better patient care.

The system 23 collects the patient numbers, station numbers, and time of scan for all charts in all chart racks in the system for a substantial period of time. These periods, for example, can be 8, 12, or 24 hours, or longer. The data can then be provided as reports to identify operation issues, such as, for example, the number of charts that remained for longer than the predetermined target time at each station. If a significant number of charts are detected in the chart racks for longer than the estimated target time in the X-ray department, for example, a report will indicate that there may be a bottleneck that needs to be addressed in that department.

A significant advantage of this system is that it requires little additional input from already busy personnel at the facility in question. This is particularly so for ER and ED personnel. All that is required of administrative personnel is that the patient check-in form be scanned and associated with a chart holder with an RFID tag to which the patient's date and time of check-in is written. The movement of the patient and the patient chart through the facility is then monitored automatically by the system. The alarm function provides immediate feedback to identify problem areas, while the report function of the system provides more detailed information about patient flow.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

1. A method for tracking patient flow through a medical or healthcare facility, the method comprising the steps of:
associating a patient chart with an RFID tag assigned a unique identification number to a patient;
associating at least one chart holder with an RFID interrogator to read the identification number corresponding to the patient chart placed within the chart holder;
linking at least one RFID interrogator associated with at least one chart holder to a monitoring system for collecting information from the RFID interrogator; and
monitoring the information from the RFID interrogator to determine the time interval between placement of the chart into the chart holder and removal of the chart from the chart holder.

2. The method of claim 1 wherein the information collected from the RFID interrogator comprises at least one patient chart and at least one corresponding time of detection of the chart in the chart holder.

3. The method of claim 1 wherein the information collected from the RFID interrogator comprises at least one chart identification number comprising a unique number programmed into the RFID tag by the manufacturer and at least one corresponding time of detection of the chart in the chart holder.

4. The method of claim 1 wherein a patent name or hospital number is associated with the patient chart.

5. The method of claim 1 further comprising notifying facility personnel when the time interval between placement of the chart into the chart holder and removal of the chart from the chart holder exceeds a predetermined time interval.

6. The method of claim 1 wherein the RFID tag is a passive tag.

7. The method of claim 1 further comprising associating at least one chart holder with each department which provides diagnostic or therapeutic services within the facility.

8. A system for tracking patient flow through a medical or healthcare facility, comprising:
at least one patient chart with an RFID tag with an identification number;
at least one chart holder with an associated RFID interrogator to read the identification number encoded in the RFID tag of each chart stored within the chart holder; and
a monitoring system operably connected to the at least one RFID interrogator for collecting from the RFID interrogator the RFID tag identification numbers of the charts stored within the chart holder at predetermined polling intervals.

9. The system of claim 8, wherein the monitoring system stores the RFID identification numbers, the time of polling, and the station number associated with the location of the chart holder.

10. The system of claim 8, wherein the RFID tag is assigned the identification number by the manufacturer.

11. The system of claim 8, further comprising alarm means operably connected to the monitoring system, said alarm means being triggered when the monitoring system determines that a patient chart has remained in or near a chart holder at a station for longer for a certain period of time.

12. The system of claim 11, wherein the period of time is predetermined for each individual chart holder at a station.

13. The system of claim 12, wherein the period of time may be adjusted based on the time of day or day of the week.

14. The system of claim 12, wherein the period of time may be dynamically adjusted.

15. The system of claim 11, the alarm means comprising a light on or near the chart holder triggering the alarm means.

16. The system of claim 11, the alarm means comprising a message or visual signal at a monitoring station operably connected to the monitoring system.

17. The system of claim 11, the alarm means comprising an audible signal at a monitoring station operably connected to the monitoring system.
